(19) United States
(12) Patent Application Publication
(10) Pub. No.: US 2009/0044729 A1
(43) Pub. Date: Feb. 19, 2009

(54) MULTI-FUNCTIONAL RUNNING BOARD AND RAMP APPARATUS

(75) Inventors: Scott Navarre, Spring Lake, MI (US); Karen Dumas, Holland, MI (US); Bob Arterburn, Grand Haven, MI (US); Rainer B. Nees, West Olive, MI (US)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: Shape Corporation

(21) Appl. No.: 12/189,953

(22) Filed: Aug. 12, 2008

Related U.S. Application Data
(60) Provisional application No. 60/956,182, filed on Aug. 16, 2007.

(51) Int. Cl. B60P 1/43; B60Q 1/24; B60P 1/44; B23P 19/04; B60P 1/00

(52) U.S. Cl. 108/44; 362/495; 296/50; 29/700; 280/727

(57) ABSTRACT

A running board system is provided for the light truck market, where a beam of the running board is removable to double as a ramp. For example, a single one of these beams can be used to guide a motorcycle onto a truck bed, or alternatively a pair of these removable beams can be used to provide a ramp for guiding a two wheel cart (e.g., hand truck), four wheel vehicle, or snowmobile onto the truck bed. Optionally, the beam includes lockable storage and/or includes brackets for securement of the beam(s) to the truck's tailgate when used as a ramp.

This application claims benefit under 35 U.S.C. §119(e) of provisional application Ser. No. 60/956,182, filed Aug. 16, 2007, entitled MULTI-FUNCTIONAL RUNNING BOARD AND RAMP.

### BACKGROUND

The present invention relates to a multi-functional running board and ramp apparatus, such as for the light truck market.

The owners of small trucks often want a ramp to assist in loading items into the truck's bed. Usually, the ramp is a separately purchased item, and is stored by throwing it into the truck bed until use. However, a disadvantage is that this requires that the ramp be put into the truck bed in anticipation of use. Further, the ramp takes up space in the truck bed decreasing storage area of the truck bed.

Various arrangements have been conceived for “double-duty” components, where the component can be used as a ramp and also used as a second functional component on the vehicle. However, known “double-duty” components tend to be overly complex, expensive, heavier than desired, not easily released, and/or not designed for use with a light weight truck.

### SUMMARY OF THE PRESENT INVENTION

In one aspect of the present invention, a running board and ramp apparatus includes a tubular beam, mounts for mounting the beam to a vehicle as a running board, and a lockable retainer for securely retaining the beam to the mounts but permitting easy removal from the mounts, the beam being configured for use as a ramp.

In another aspect of the present invention, a vehicle includes a vehicle body with sides, and a running board system mounted to sides of the vehicle body, the running board system including at least one roll-formed beam having a constant cross section and including mounts for removably mounting the beam to the vehicle for use as a running board, with the beam being easily removable and useable as a ramp.

In another aspect of the present invention, a method comprises steps of roll forming at least one beam, attaching the at least one removable beam to a vehicle to form a running board on at least one side of the vehicle; removing the beam from the vehicle; and placing the beam against the vehicle for use as a ramp.

The present inventive concepts include several advantages offered by the multi-functional design, including: dual function as ramp and running board in one design, reduction of part complexity, simplified of attachment in both locations/functions, corrosion resistant design and wide choice of materials, robust design, and a lightweight attachment/detachment mechanism. Further, in some versions, the present beams are roll-formed. Thus, they can be formed in high volume and at relatively low cost using roll forming processes, but with materials having a very high strength-to-weight ratio and minimal thickness.

These and other aspects, objects, and features of the present invention will be understood and appreciated by those skilled in the art upon studying the following specification, claims, and appended drawings.

### BRIEF DESCRIPTION OF DRAWINGS

FIG. 1 is a side view of a light-weight truck including a running board and ramp system embodying the present invention.

FIGS. 2-2A are perspective and side views of the running board and ramp system of FIG. 1.

FIGS. 3-3A, 4-4A, 5-5A,6-6A, 7-7A, 8-8A, 13-14, and 22-23 are perspective and side views of alternative embodiments of the running board and ramp system; and

FIGS. 9-10, 11-12, 15-16, 17-18, 19-20, and 24-25 are perspective views of additional modified embodiments, FIGS. 21A-21C being side views and showing an assembly sequence for the arrangement of FIG. 20.

### DETAILED DESCRIPTION OF PREFERRED EMBODIMENTS

A running board and ramp system (also called a multifunctional running board and ramp apparatus) is provided such as for use in the light truck market, where a beam functioning as a running board on the vehicle can be removed and used as a ramp to facilitate loading items into the truck's bed. For example, a single beam can be used as a ramp for loading a motorcycle onto a truck bed, or alternatively a pair of these removable beams can be used to provide a ramp for guiding a two-wheel material handling cart or a four wheel off-road vehicle onto the truck bed. This enables the user to load/unload heavy items without the strain of lifting the heavy items onto the rear truck bed. The multi-function of this system eliminates the need to have and transport separate ramps and attachment mechanisms, because the running boards act as ramps and running boards in one consolidated design. In several embodiments, the beams are roll-formed so that they can be made in high volume and at low cost, but with high-to-weight strength materials that are difficult to bend and that cannot easily be formed using traditional stamping and bending operations. For example, roll forming processes can be used to form very high strength materials, such as steels having 80 ksi tensile strength and less than 3 mm sheet thickness, or even materials having 120 ksi tensile strength and 1.0 to 2.2 mm sheet thickness. However, it is contemplated that other materials can also be used, as illustrated in the embodiments below.

A quick detachment mechanism allows the running boards (i.e. beams) to be quickly detached from the vehicle side with out use of hand tools. The beams/running boards then will be attached to (or simply placed on) the rear portion of the lowered tailgate or onto a top of the tailgate. It is contemplated that the beams/running boards can be fastened into position on the truck's tailgate using the same type fastener as previously used when the beam was attached as a running board. It is contemplated that the attachment system can be made lockable for security and stability. Also, it is contemplated that additional features can be added to the apparatus, such as lights (where the lights highlight the beam when used as a running board and/or when used as a ramp), storage (covered compartments within the beam, such as for tools for changing wheels/tires), beam-to-beam connectors (for interconnecting beams to provide a double-wide ramp or a double-long ramp), telescopingly-connected beams that can be extended or retracted during use, and/or end-connectable beams (where beams are connectable end-to-end at a joint and include a leg supporting the beams at a mid-point under the end-to-end joint), and/or beams adapted for use as a short ladder (apertures forming foot-holds or “rungs” on one side of the beam).

Advantages of the multi-functional design include the following: 1) dual function as a ramp and running board in one design; 2) reduction of part complexity, 3) simplified attachment in both locations/functions, 4) corrosion resistant design, 5) robust, lightweight attachment/detachment mechanism, 6) easy access both in terms of access and removability, and 7) high strength-to-weight ratios in combination with the low cost and high volume capabilities of roll forming methods.

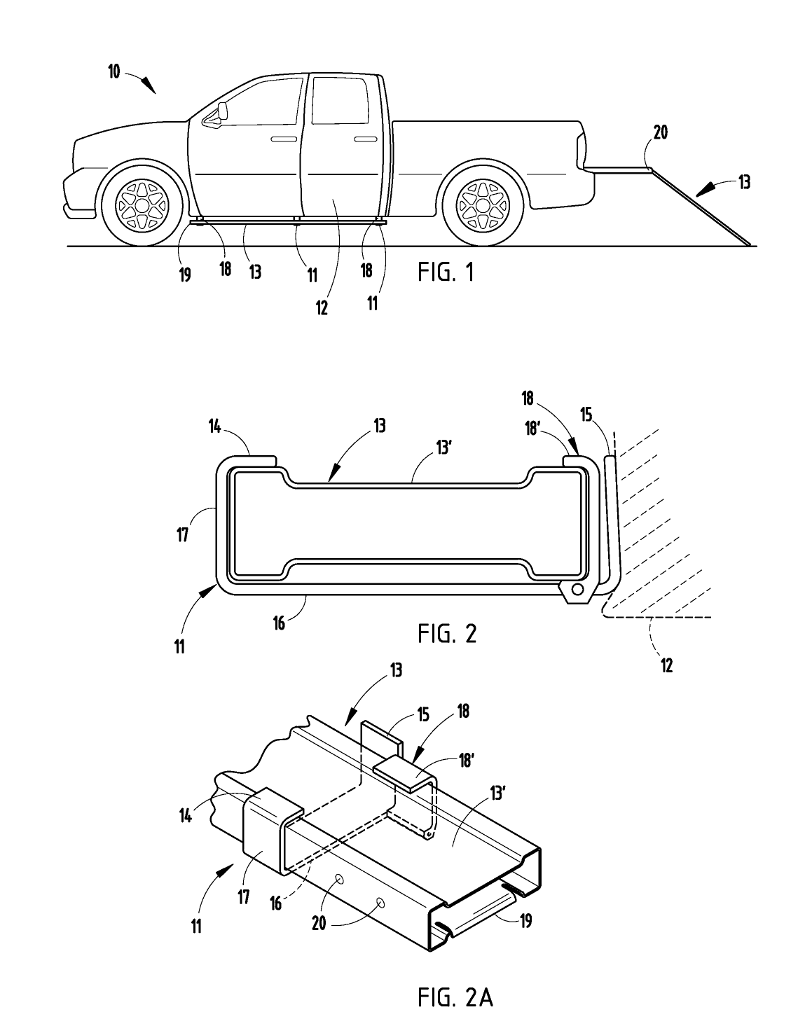

FIG. 1 discloses a toe-in clasp arrangement where a runner board system 10 (also called multifunctional runner board and ramp apparatus) includes two (or more) spaced-apart mounts 11 attached to a side of a frame of a vehicle 12, and a beam 13 secured by the mounts 11 to the vehicle 12. The particular mount 11 includes a C-shaped bracket with inboard flange 15 for attachment to the vehicle frame 12, bottom flange 16, outboard flange 17 and lip flange 14 configured to matably receive and support the beam 13. The beam 13 includes a width, height, length and desired top surface finish (either roughened or treated for frictional characteristics, and/or having a channel guide formed to prevent slip-off). The material, cross sectional shape and length of the beam 13 make it suitable in strength and surface texture for use as a non-slip running board and for use as a ramp. It is contemplated that the beam 13 can be made of any material suitable for its intended purpose, including a reinforced polymeric material, steel, aluminum, composite, or other materials. It is contemplated that the beam 13 can be made by suitable manufacturing processes, such as injection molding, compression molding, extrusion, stamping, roll forming, and other processes.

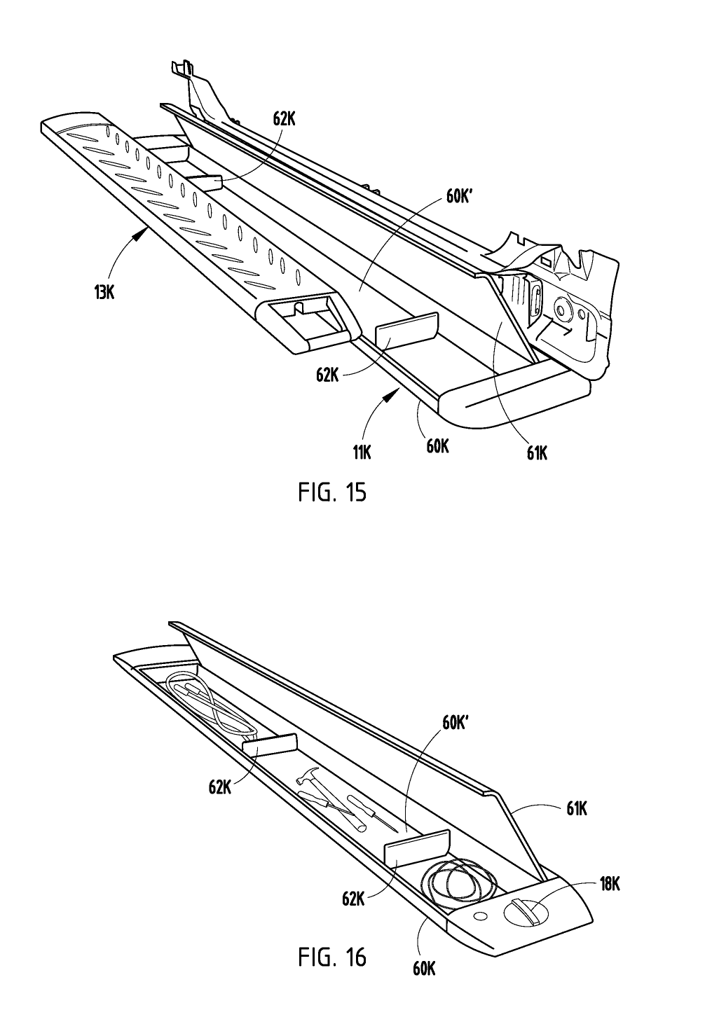

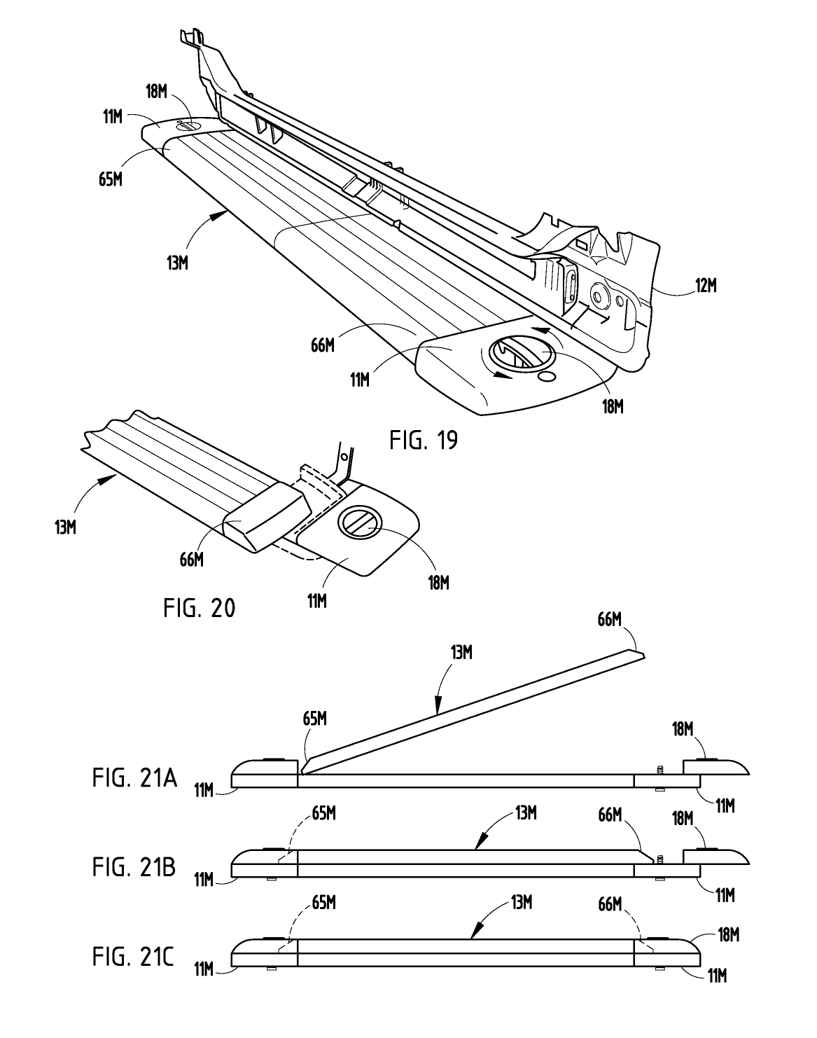

As illustrated in FIG. 2-2A, the beam 13 is tubular and has a “dog-bone” shaped cross section, which provides substantial beam strength as compared to an open channel (such as a C-shaped beam). A shallow channel is defined in the top (and bottom) walls of the beam 13 to act as a wheel guide to reduce a tendency to slip off the beam when stepping thereon (i.e., as a running board). Also, the channel provides a track for wheels, such as when pushing a two-wheeled cart up the ramps into a truck bed. Also, the illustrated beam 13 is roll-formed, allowing it to be made from high strength materials and in high volume yet at competitive cost. (See Sturrus U.S. Pat. Nos. 5,092,512 and 5,104,026, both of which are incorporated herein in their entirety for their teachings of an apparatus and method for roll forming tubular shapes and beams.) For example, the beam 13 can be made of high strength steel such as greater than about 80 ksi tensile strength and thickness less than 3 mm, or even greater than 120 ksi tensile strength and thickness between about 1.0 mm and 2.2 mm. The illustrated beam 13 has a continuous constant cross section, but it is contemplated that the upper (or lower) walls can be embossed with a pattern of short angled ribs (see FIG. 15) (or transverse ribs of FIG. 22 or longitudinal ribs of FIG. 19) to provide increased frictional property, such as to reduce the tendency of a person standing thereon to slip. Notably, a hook connector 19 (FIG. 2A) can be integrally formed with beam 13 (or tack welded or otherwise attached to the end of the beam 13), or can be integrally formed from a wall of the beam. The hook connector 19 can be used to attach the beam 13 to a mating slot or crevice in the tailgate to retain the beam 13 thereto . . . or can be designed to engage one of the mounts 11 to retain the beam 13 longitudinally when used as a running board. The mounts 11 and/or the retainers 18 can instead include a protrusion 18′ that fits into a hole in the beam 13 for holding the beam longitudinally on the vehicle.

The inboard and outboard side sections of the illustrated beam 13 are enlarged for beam strength and bending stiffness, and are shaped to matably fit between the inboard and outboard flanges 15 and 17 of the mounts 11 under lip flange 14 for secure (but releasable attachment) to the vehicle. A center top surface of a top wall (or bottom wall) of the beam 13 is relatively flat but can roughened or embossed with short channel-shaped ribs for good non-slip engagement by a person's foot (when getting into the vehicle) or for non-slip engagement by a tire (when loading a vehicle into the truck bed). The illustrated finger retainer 18 is pivoted to the mount 11 and is movable to a retaining position for securing the beam 13 to the mounts 11 when in its runner-board position. Notably, the retainer 18 can be located adjacent the vehicle's body, or adjacent an outer end of the mount 11.

To insert the beam 13 onto the mounts 11, and outer edge of the beam 13 is tipped into position under the flange 14 and then laid onto the wall 16 of the mount 11, and then the retainer 18 is moved from its inboard release position to a vertical locked position (as illustrated). The retainer 18 is pivoted to the mount 11 (or to the vehicle frame), and includes a retaining top lip 18′ that in combination with a top lip 14 on the outer flange 17 securely captures the beam 13. Notably, the retainer 18 is configured to allow easy removal of the beam 13 without the need for separate tools. The illustrated retainer 18 is made to frictionally hold itself in its locked position, but it is contemplated that a lock can be added if desired, such as by providing a key lock with tab movable to engage (and disengage) the channel in the top of the beam 13 . . . thus preventing the retainer from being pivoted from the locked position to the release position. (See the locks in FIGS. 7A and 8.)

It is contemplated that options and/or accessories can be added to the beams 13 and to the apparatus 10. For example, the beam 13 can have an end connector 19 (integrally formed with the beam or attached as a separate part via welding or screws) for stably securing the beam 13 to a vehicle tailgate when used as a ramp. For example, the connector 19 could be hook-shaped (FIG. 2A) and adapted to engage a slot in the tailgate (see FIG. 1). Alternatively, the connector 19 can be configured to engage another opening or feature in the truck, such as the open space defining a slot between a tailgate and the truck bed. It is also contemplated that the connector (19) could be magnetic, a tether strap, or other structure adapted for securing the beam to the vehicle for use as a ramp. Also, it is contemplated that lights 20 can be attached to or imbedded into the beam 13 along its sides (and/or on the beam's top or bottom). Electrical power would be communicated to the lights 20 via wiring that extends within the beam 13 to an electrical connector adjacent one of the mounts 11. It is contemplated that the electrical connectors could designed to be manually connected (or to automatically connect) establish a circuit with the vehicle's electrical system when the beam 13 is installed onto the mounts 11 for use as a runner board . . . and/or also to electrically connect when the beam 13 is placed on and attached to the vehicle's tailgate for use as a ramp.

The beam 13 also can be designed to incorporate other functional features, such as storage compartments (see FIG. 16) in the center or side areas of the beam in FIG. 2. This could be done by providing holes or apertures in the wall 13′. It is contemplated that the storage compartments would be covered with access covers to prevent buildup of dirt and debris. For example, the covered compartments can be adapted to store tools for changing wheels/tires. When the beam 13 incorporates a cover, it is contemplated that the cover will be on the bottom side when the beam is used as a ramp.

It is also contemplated that the beams 13 can include connectors for interconnecting a pair of the beams together in adjacent positions to provide a “single” double-wide flat ramp. A particular side-to-side connector is not illustrated, but for example, the mechanical connectors could have a laterally-extending hook-like shape or headed protrusion for fitting into a mating hole in the adjacent beam. Also, the beams can be configured to longitudinally telescope together in an extendable/retractable arrangement, or can be configured to abuttingly connect end-to-end. In both cases, the beams would potentially include a drop-down leg supporting a middle of the beam(s) under the “joint” for added support in the center of the ramp. Alternatively, a car jack could be used for this center support. Also, it is contemplated that the beams could be adapted for other uses such as a short step ladder by incorporating a series of enlarged apertures in the top and/or bottom walls to form therebetween “rungs” on the beam.

In the following discussion, similar parts, components, and features are identified using similar numbers but with the addition of a letter “A,” “B,” etc. This is done to reduce redundant discussion.

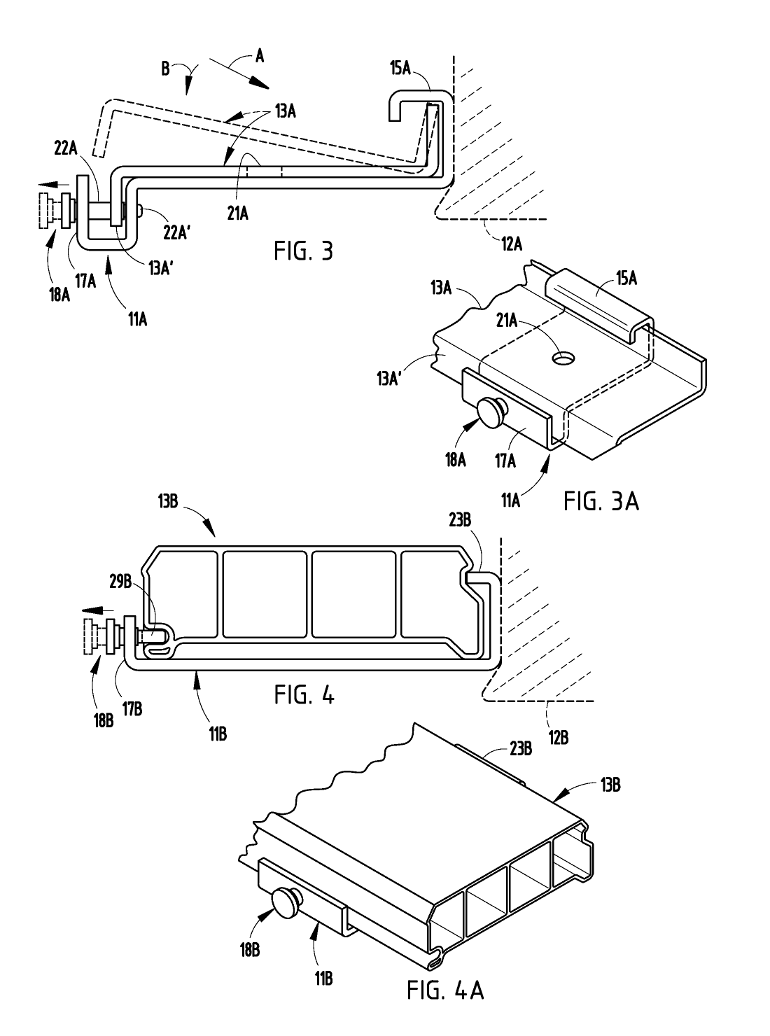

FIGS. 3-3A discloses a “tip-in” arrangement that is similar to FIGS. 2-2A, but the beam 13A has a roll-formed Z-shaped cross section, and the mounts 11A are adapted to matably receive the beam 13A as the beam 13A is tipped and then manipulated along directions A and B into its runner board position. When installed as a runner board, the beam 13A has a top surface that is horizontally positioned for non-slip stepping as a person steps on the runner board. An outer edge of the beam 13A can be lifted to tip the beam 13A out of its interlocked storage position, which causes the inboard edge of the beam 13A to move downward and out from the downwardly-capturing inboard flange 15A of the mount 11A. In a fore-aft direction, the beam 13A is retained in the runner board position by a retainer 18A that includes a protrusion 21A or by end caps on the mounts. It is contemplated that the outboard flanges 16A, 17A of the beam 13A can be angle cut near its end to facilitate its use as a ramp such as by cutting off some of the flanges near an end of the beam where the flanges extend below the horizontal center wall of the beam (i.e., so that the outboard down flanges 13A′ do not engage the ground to prevent the beam 13A from resting in a flat ramp-forming position). The retainer 18A includes a spring-biased pin 22A mounted to the outer end of mount 11A. The pin 22A has a tip 22A′ biased into engagement with a hole in the outer flange 13A′ of the beam 13A and into an aligned hole in the mount 11A. The pin 22A can be pulled against the bias of the spring to a retracted position, so that the beam 13A can be removed from the mounts 11A.

FIGS. 4-4A disclose another “tip-in” arrangement that is similar to FIGS. 3-3A, but where the beam 13B is an extruded aluminum or plastic material (or alternatively a roll-formed or stamped and welded construction). The illustrated beam 13B has multiple internal vertical walls such that it is multi-tubular. However, it could include any number of internal walls (or zero internal walls) depending on functional requirements. The beam 13B is shaped to include relatively flat top and bottom walls, except the bottom wall defines a channel that can be used to guide a rolling wheel when using the beam 13B as a ramp. The inboard and outboard walls include side channels, with the channel on the inboard wall being adapted to receive a mating fixed protrusion 23B on the inboard flange 15B of the mount 11B, and the outboard wall being adapted to receive a spring-loaded pin 29B of a retainer 18B. It is contemplated that the spring-loaded pin 29B could be replaced with a threaded or partial-turn fastener that extends through the outboard flange 17B into the outer channel.

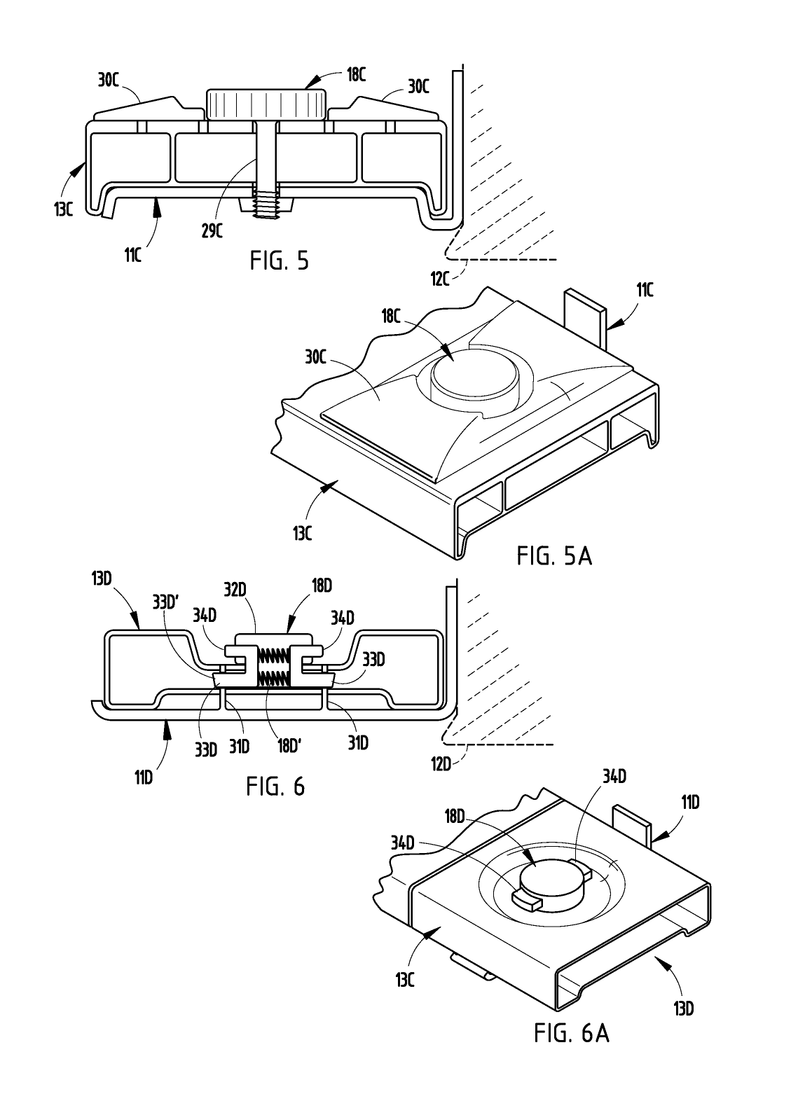

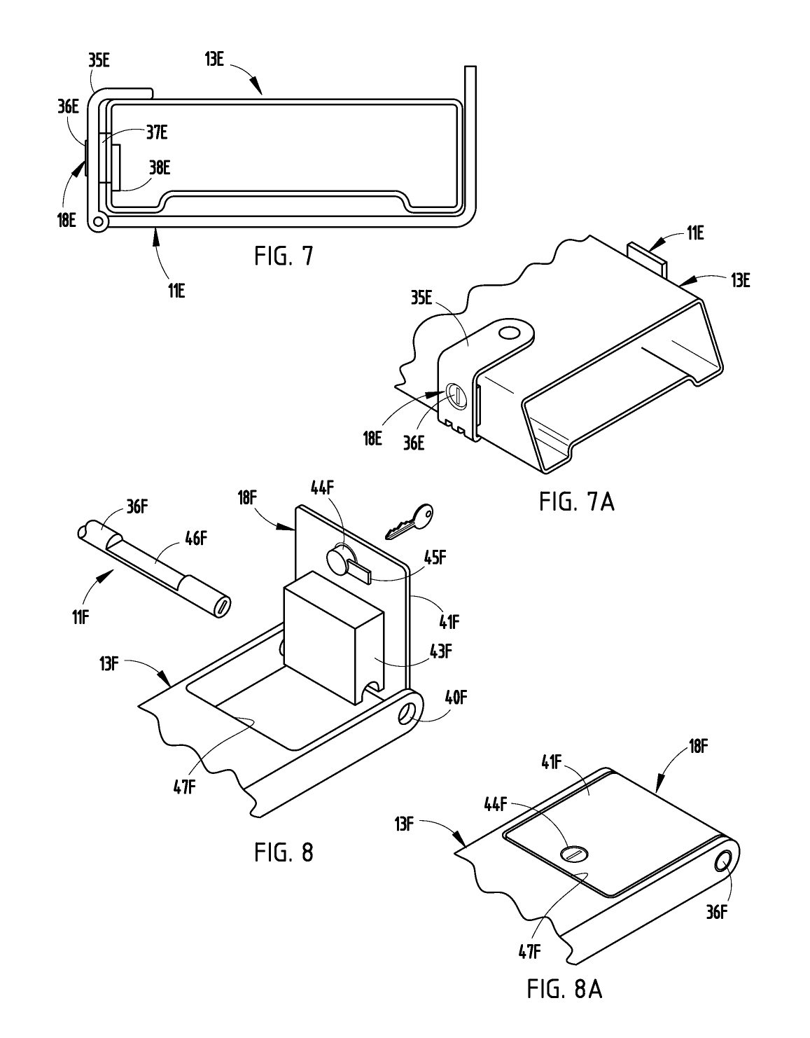

FIGS. 5-5A disclose a second extruded beam arrangement that not totally unlike the arrangement in FIGS. 4-4A. In FIGS. 5-5A, the beam 13C is an extruded aluminum or plastic part, with its top wall being one thickness, and its side and bottom walls and internal reinforcing ribs being a thinner thickness (such as about half the thickness of the top wall). The beam 13C sets vertically onto the mounts 11C, and includes a contoured concave bottom wall that matably engages the dome-like-shape of the mount 11C, including straddling a raised center portion of the mounts 11C. The outboard flange (17) is eliminated. A retainer 18C is provided in the form of a threaded screw 29C that extends vertically through the beam 11C into threaded engagement with a threaded hole in the mounts 11C and/or into a threaded nut attached to the mounts 11C. A raised topper 30C, such as an aesthetic plastic tread/trim piece, is attached atop the beam 13C to protect the head 30C′ of the screw 29C. The topper 30C can be as long or short as desired.

FIGS. 6-6A disclose an arrangement similar to FIGS. 5-5A, but the threaded screw retainer/screw 29C is replaced with a retainer device 18D defining a finger-pinched releasing mechanism 18D′. The beam 13D has vertical apertures in its lower wall, and the mounts 11D have vertical finger-like center flanges 31D that extend through the apertures when the beam 13D is placed on the mounts 11D. The retainer 18D includes a housing body 32D, and a pair of C-shaped spring-loaded laterally-extending pins 33D for laterally engaging apertures 33D′ in the center flanges 31C to secure the beam 13D to the mounts 11D. The C-shaped pins 33D define a pair of outwardly-biased release buttons 34D that can be compressed to retract the pins 33D, thus releasing the beam 13D. A key lock can be incorporated into the body 32D to allow the pins 33D to be locked in an engaged/locked position. It is contemplated that a variety of other similar retainer arrangements are possible that utilize spring-loaded pins.

FIGS. 7-7A disclose a hinged clasp arrangement that is similar to FIGS. 2-2A, but the retainer 18E includes an L shaped clasp 35E that can be moved to retain (or release) the beam 13E from the mounts 11E. A lock 36E is attached to the clasp 35E, and includes a cylinder 37E with laterally-extending locking finger 38E. The cylinder 37E and finger 38E fit through an aperture in a side wall of the beam 13E, allowing the locking finger 38E to be rotated to lock the clasp 35E in position and thus locking the beam 13E onto the mounts 11E. The beam 13E has an angle-cut end (FIG. 7A) so that the beam 13E engages the ground in a stable manner with angled lead-in tip when used as a ramp.

FIGS. 8-8A disclose a hinged clasp arrangement that is similar to FIGS. 7-7A, but the beam 13F includes laterally-facing holes 40F that are configured to laterally/horizontally receive horizontal mounting pins 36F of the mount 11F. The retainer 18F includes a body 41F (also called a “cover” herein) pivoted to the end of the beam 13F by pivots 42F for movement about a transversely-extending axis. The retainer 18F includes a block 43F and key lock 44F with locking finger 45F that are attached to the body 41F. The pin 36F includes a notch 46F. When the beam 13F is positioned on the mounts 11F with the pins 36F extending through the holes 40F, the body 41F can be pivoted to a closed position where the block 43F engages the notch 46F. In this closed position, the body 41F forms an end of the top surface of the beam 13F. The block's engagement with the notch 46F prevents lateral removal of the beam 13F from the pins 36F. When the body 41F is in its closed position, the finger 45F of the key lock 44F is positioned so that upon rotation using a key in the key lock 44F, the finger 45F extends under the edge 47F of the beam to lock the body in the notch 46F. This arrangement reduces stress on the finger 45F while still providing a very positive and secure locking arrangement when the beam is in its running board position.

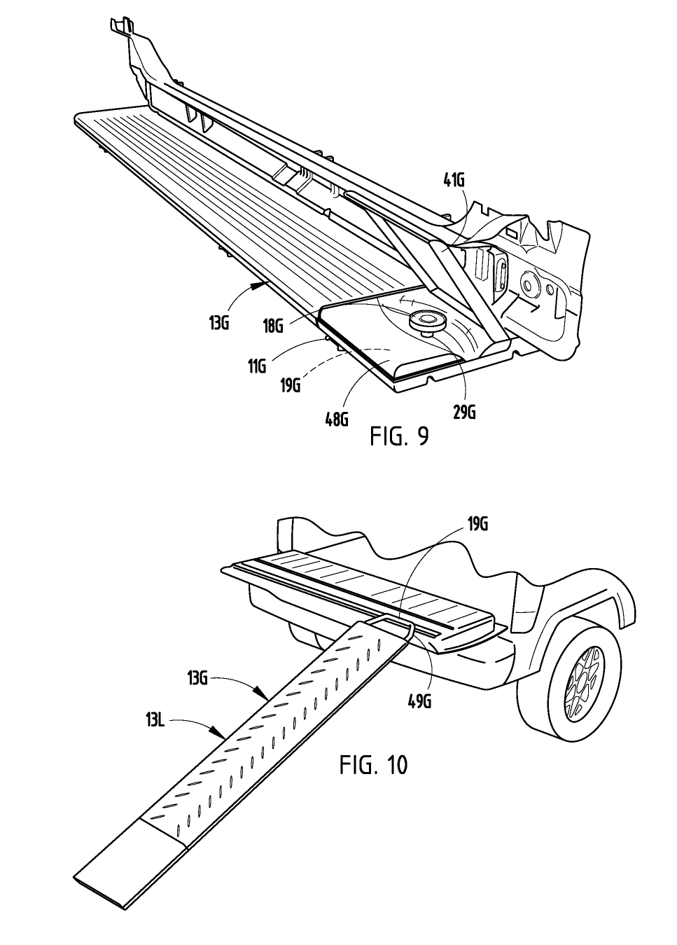

FIG. 9 discloses an arrangement similar to FIGS. 5-5A, but includes a cover 41G pivoted to a side of the beam 13G for pivotal movement in a direction transverse to a length of the beam. The cover 41G is similar to the cover 41F in FIG. 8, but pivots in a different direction and frictionally snaps into its closed position. Also, the retainer 18G utilizes a screw 29G and the cover 41G is configured to aesthetically cover and protect the screw 29G when the beam 13G is in its running board position. Notably, a top of the beam 13G includes linear embossments for providing a rough non-slip surface.

FIGS. 9 and 10 disclose that an end of the beam 13G can include a U-shaped connector 19G, which is similar in function to the previously-disclosed connector 19 but which has less sharp edges. The connector 19G forms a loop at an end of the beam 13G that can be used to engage a matingly-shaped channel at location 49G for gravitationally attaching the beam 13G to the vehicle's tailgate. It is contemplated that the connector 19G can be made fixed, or can be made to be pulled telescopingly out from an end of the beam 13G, with legs of the connector 19G slidingly engaging mating tracks in the beam 13G. The loop connector 19G fits onto the mount 11G (FIG. 10) and a plate 48G covers the loop connector 19G, with the screw 29G holding down the plate 48G.

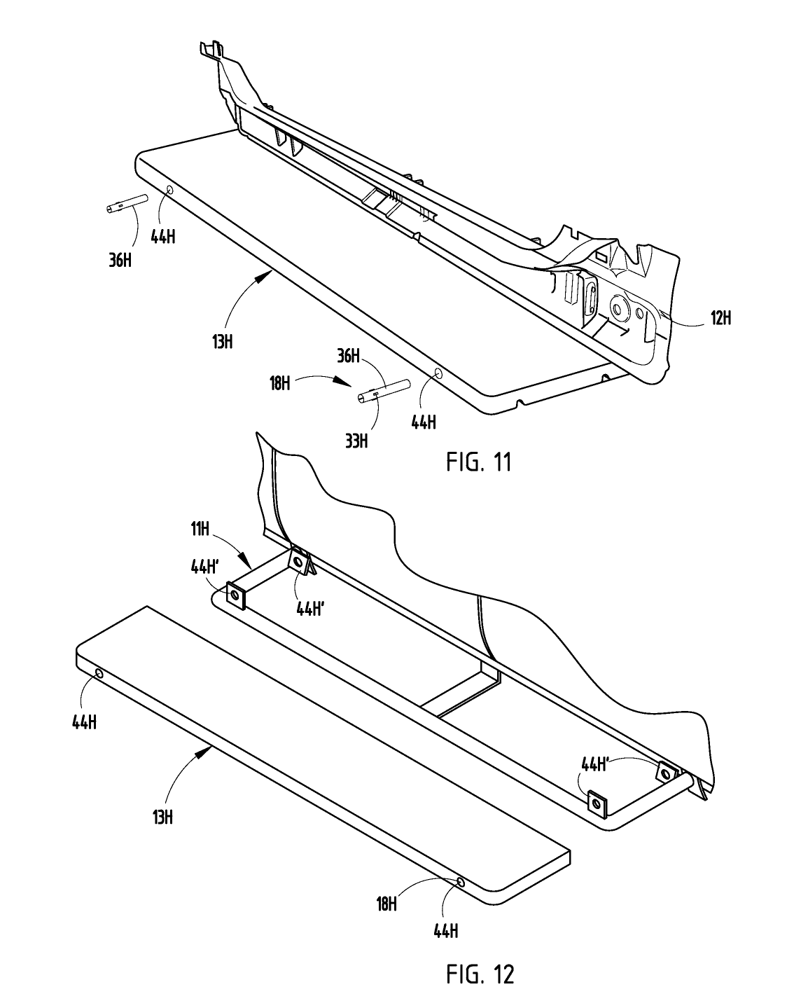

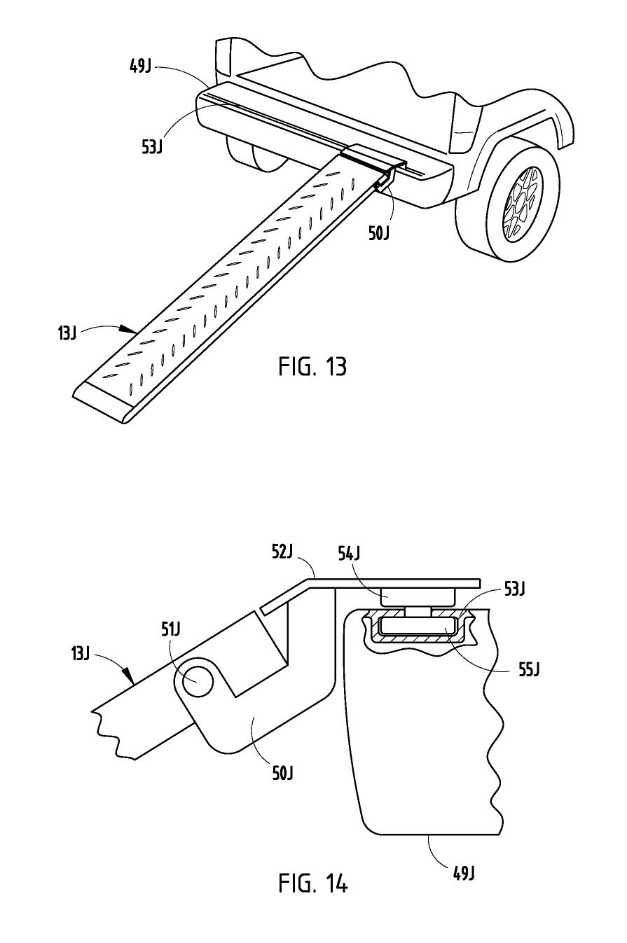

FIGS. 11-12 disclose an arrangement where a beam 13H includes side holes 44H that align with holes 44H′ on the mounts 11H. The retainer 18H includes horizontal mounting pins 36H that engage holes 44H and 44H′ of the mount 11H. The ends of the pins 36H can incorporate key locks 44H and include radially-extendable fingers 33H configured to engage an inner surface of the beam when the lock 44H is rotated to a locked position. The mounts 11H are formed by a bent tube attached at both ends to the vehicle frame with brackets welded thereon to form the holes for retainers 18H.

FIGS. 13-14 disclose an arrangement where a more positive attachment is used to attach a beam 13J to a tailgate 49J as an angled ramp. The beam 13J includes a bracket connector 50J attached to the beam 13J by pivots 51J. A sheet portion 52J forms a bridge for providing a smooth transition from the ramp (i.e., beam's top surface) onto the tailgate. The tailgate 49J includes a channel 53J with internal cavity. A protrusion 54J with enlarged head 55J is shaped to slide laterally into the channel 53J for securely connecting the beam 13J to the tailgate 49J. By this arrangement, the beam 13J can be adjusted laterally to a desired position, yet the connection is very positive so that the beam 13J cannot accidentally slide off a rear of the tailgate and fall to the ground during use. Notably, it is contemplated that the protrusion 54J can include a threaded member or clamp that can be tightened to fix the lateral position of the beam 13J on the tailgate 49J. In fact, the threaded member can be the same one that is used as the retainer for securing the beam to the mounts on the vehicle in a running board position. (See retainer 29C, FIG. 5.)

FIGS. 15-16 show an arrangement where the mount 11K includes a structural lower part 60K forming a compartment and a cover 61K forming a structural upper part. The structural lower part 60K includes walls defining storage pockets, such as pocket 60K′. When closed, the parts 60K and 61K combine to form a running board supported by mounts 11K. The storage pocket is shaped to matably removably receive the beam 13K. Notably, when the ramp is not used, the pocket can be used to store other items, such as tools, a car jack, etc. (See FIG. 16.) Notably, the lower part 60K potentially includes a variety of protrusions 62K and other structure forming divided pockets, yet that are configured and arranged with pass-through notches to receive the vertical walls of the beam 13K without interference. A 90 degree rotatable retainer 18K includes a locking finger for positively holding the cover 61K, thus capturing beam 13K.

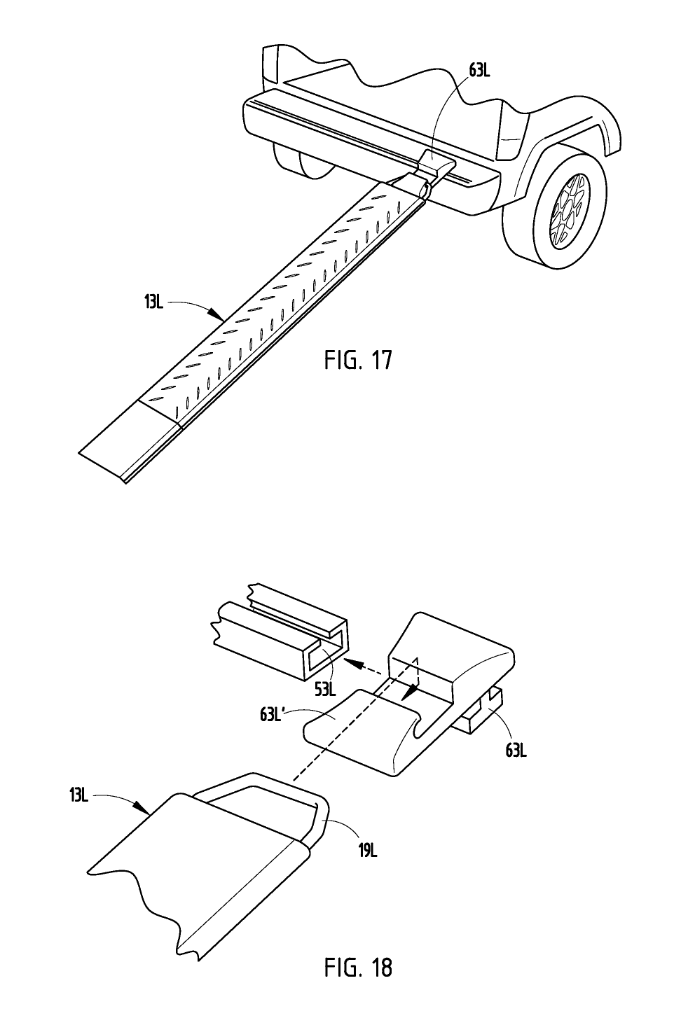

FIGS. 17-18 show an arrangement similar to FIGS. 9-10 and FIGS. 13-14, but where the connector 19L is a separate component from the beam 13L. The connector 19L defines a loop recess for receiving the loop connector 19L on an end of beam 13L and is configured to secure the beam 13L to the tailgate and to provide a smooth transition from the ramp onto the truck bed. The connector 19L includes a first portion 63L for releasably securely engaging a slot 53L (or other structure) on the truck's tailgate. Alternatively, the portion 63L can include a protrusion or magnet for securement to a part of the tailgate.

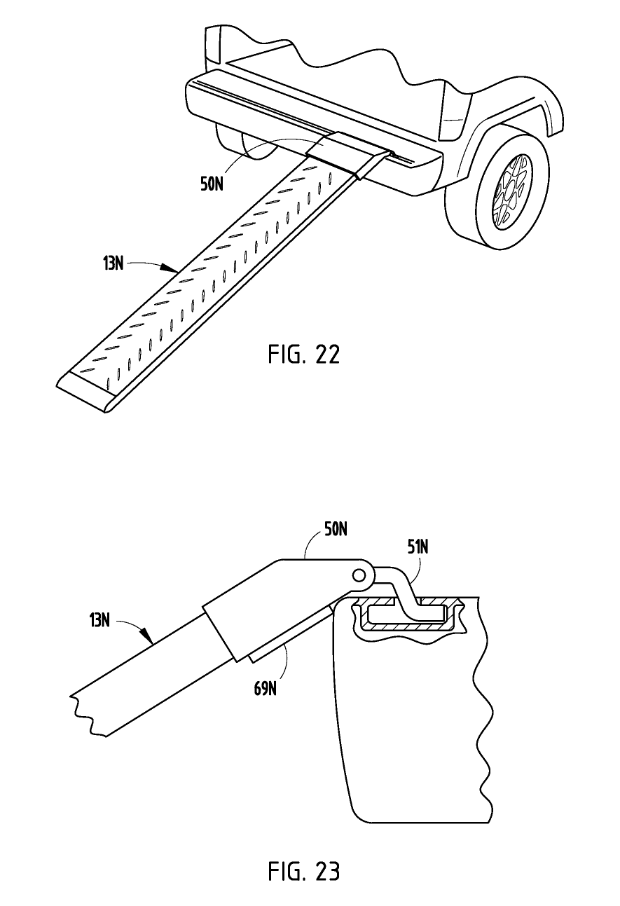

FIGS. 19-20, 21A-21C show an arrangement similar to FIGS. 8 and 8A, but the beam 13M includes a front end 65M that fits nose-first into a rear (or front) mount 11M. The other end 66M then sets vertically downwardly onto the rear mount 11M. A retainer 18M similar to the retainer 18F in FIG. 8 is pivotally or slidably attached to the beam 13M (or to mount 11M) and is used to secure the second end of the beam 13M in place. The front and rear mounts 11M and/or the retainer 18M may include a key lock for additional security.

FIGS. 22-23 show an arrangement similar to FIG. 14, but the bracket connector 50N for securely connecting to the tailgate includes a Z-shaped tongue 51N that engages the channel 53N in the vehicle's tailgate. The tongue 51N can be fixed, or alternatively can be pivotally attached to the beam 13N for movement between a stored position and an extended use position, as shown in the FIGS. 22-23. A rubber pad 9N can be provided on the ramp/beam 13N to protect the tailgate. Preferably, a top of the beam 13N includes horizontal embossments or surface treatments for creating a non-slip surface.

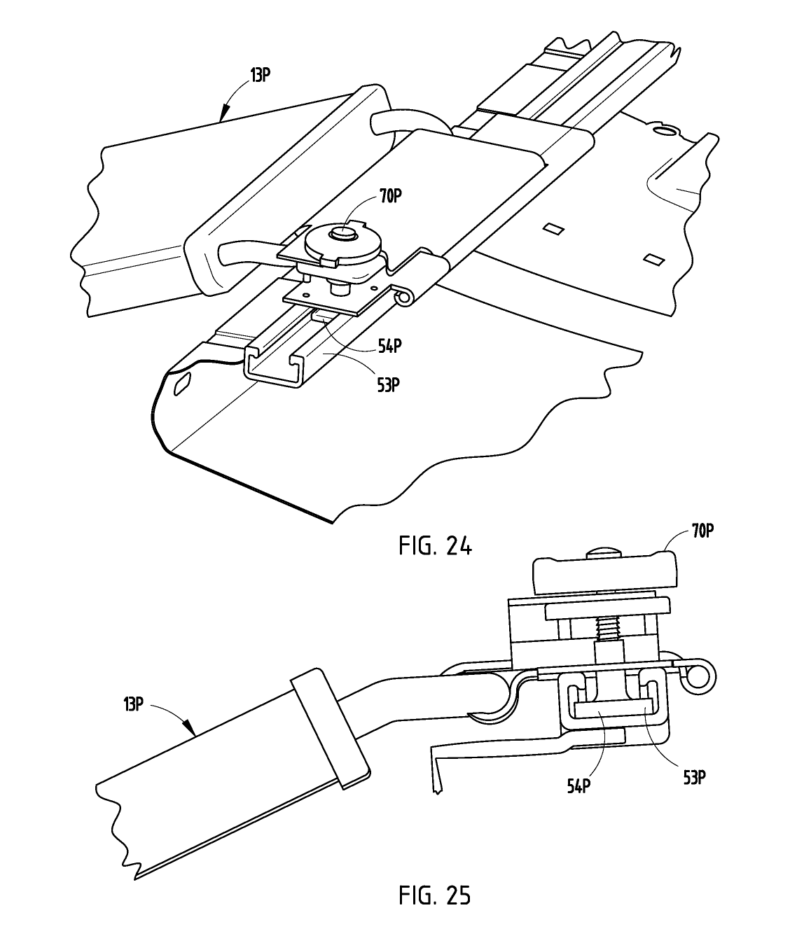

FIGS. 24-25 show an arrangement similar to FIG. 14, but modified to include a side-effect top nut 70P that can be rotated to secure the protrusion 54P by positively clampingly securing the beam 13P to the channel 53P on the tailgate.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. A running board and ramp apparatus comprising:
a tubular beam; and
mounts for mounting the beam to a vehicle as a running board; and
a lockable retainer for securely retaining the beam to the mounts while allowing the beam to be easily removed from the mounts and where the beam is configured for use as a ramp.

2. The apparatus of claim 1, wherein the beam is roll-formed and includes a constant cross-sectional shape.

3. The apparatus of claim 1, wherein the beam includes channels in at least one of top and bottom walls.

4. The apparatus of claim 1, where the beam has a cross section defining a dog-bone shape.

5. The apparatus of claim 1, wherein the beam has a material tensile strength of at least 80 ksi, and a thickness less than 3 mm.

6. The apparatus of claim 1, wherein the beam is removable without the use of separate tools.

7. The apparatus of claim 1, wherein the mounts include retainers for securing the beam to the mounts, the retainers releasably engaging the beam ends to facilitate removal of the beam.

8. The apparatus of claim 1, wherein the beam comprises a C-shaped channel in at least one wall having a depth, width, and length suitable for use as ramp.

9. The apparatus of claim 1, wherein the beam is roll-formed.

10. The apparatus of claim 1, wherein the beam defines a tubular shape.

11. A vehicle comprising a vehicle body including opposing sides, and including at least one of the beams defined in claim 1 and further including at least one of the mounts defined in claim 1, the mounts being attached to at least one of the sides and supporting an associated one of the at least one beams.

12. The apparatus of claim 1, including lights positioned along the beam and an electrical conductor connected to the lights and having a connector for connection to a vehicle electrical system for power.

13. The apparatus of claim 1, wherein the beam includes walls forming a storage compartment.

14. The apparatus of claim 1, wherein the beam defines a storage cavity and includes an accessory opening to access the storage cavity, and further includes a cover for covering the access opening.

15. The apparatus of claim 14, wherein the cover is lockable.

16. The apparatus of claim 1, wherein the beam includes at least one end configured to matably engage a connector on a tailgate of the vehicle.

17. A vehicle comprising:
a vehicle body including right and left sides;
a running board system mounted to sides of the vehicle body, the running board system including at least one roll-formed beam having a constant cross section and including mounts for removably mounting the beam to the vehicle for use as a running board, with the beam being easily removable and useable as a ramp.

18. A method comprising steps of:
roll forming at least one beam;
removably attaching the at least one beam to a vehicle to form a running board on at least one side of the vehicle;
removing the one beam from the vehicle; and
placing the beam against the vehicle for use as a ramp.
